(19) United States
(12) Patent Application Publication
(10) Pub. No.: US 2011/0112999 A1
(43) Pub. Date: May 12, 2011

(54) METHOD FOR PREDICTING AND WARNING OF WAFER ACCEPTANCE TEST VALUE

(75) Inventors: YI-FENG LEE, TAIPEI COUNTY (TW); SHIH CHANG KAO, KAOHSIUNG CITY (TW); YUN-ZONG TIAN, TAICHUNG COUNTY (TW); WEI JUN CHEN, TAICHUNG COUNTY (TW)

(73) Assignee: INOTERA MEMORIES, INC., TAOYUAN COUNTY (TW)

(21) Appl. No.: 12/703,999

(22) Filed: Feb. 11, 2010

(30) Foreign Application Priority Data
Nov. 6, 2009 (TW) 98137722

(51) Int. Cl. G06N 3/10; G06F 15/18

(52) U.S. Cl. 706/20; 706/21

(57) ABSTRACT

A method for predicting and warning of WAT value includes the steps as follows. A key process is selected and a WAT value after finishing the key process is used as a predictive goal. A predicting model is built. One batch or plural batches of predictive wafers are prepared, and a Fault Detection and Classification data (FDC data) and a metrology data from the predictive wafers of the key process are collected. The FDC data and the metrology data collected from the predictive wafers are inputted into the predicting model for processing a normal predicting procedure, and a predictive WAT value by the predicting model is outputted. The present invention can accurately predict the WAT value, effectively monitor some specific defective wafers and continuously perform the improvement for the specific defective wafer.

### BACKGROUND OF THE INVENTION

1. Field of the Invention

The present invention relates to a method for predicting and warning of WAT (Wafer Acceptance Test) value, and more particularly to a method which can accurately predict the WAT (Wafer Acceptance Test) value during manufacturing process without any practical test after a predicting model of WAT (Wafer Acceptance Test) value is built, and warning the relative responsible person of abnormal WAT (Wafer Acceptance Test) value.

2. Description of Related Art

The semiconductor wafer manufacturing yield closely affects the product cost and industry competition, so that the semiconductor industries unceasingly endeavor and research to improve and raise the yield as their goal. The fabrication of ICs on the wafer requires that the wafer 100 undergo a large number of relatively complex process steps, with potential process faults occurring at each process step. In semiconductor fabrication processes, the WAT (Wafer Acceptance Test) is usually performed to test some wafers after some manufacturing processes. Some sample wafers are tested by a WAT tool (measuring equipment), so that a WAT (Wafer Acceptance Test) value associated with the manufacturing process is obtained.

When the WAT (Wafer Acceptance Test) is preformed, a simulated circuit of custom's design and a monitoring for the stability and the yield rate of the process play an important role in wafer manufacture. Basic electrical parameters signify that if the dice located on the wafer can normally operate or not. Thus, the electrical parameters which are measured need to match the original predetermined electrical parameters, and the abnormal basic electrical parameters is used reflect to the problems on manufacturing line.

However, the WAT (Wafer Acceptance Test) needs to spend much time for testing, so that it is impossible to test all of the wafers. To save the time cost, each batch of the wafers usually is only sampled out a part for testing, for example, 3 or 5 wafers among 25 wafers are selected. Furthermore, the tested sampling wafers are usually chosen after the middle-processes or the post-processes are finished. Therefore, the quality of all wafers can not be controlled certainly and fully by the WAT (Wafer Acceptance Test). Some defective wafers which are not chosen to test will be delivered to the custom end. There is certain loophole in the quality controlling.

Moreover, even the defective wafers are found during testing, the manufacturing engineer only can trace back to some possible problems in processes. The defective wafers can not be performed any improved method in advance.

### SUMMARY OF THE INVENTION

It is therefore an object of the invention to provide a method for predicting and warning of WAT (Wafer Acceptance Test) value, which can predict accurately the WAT (Wafer Acceptance Test) value and does not need to practically perform the WAT (Wafer Acceptance Test). Furthermore, the present invention can effectively monitor some specific defective wafer and continuously perform the improvement for the specific defective wafer.

According to the present invention, a method for predicting and warning of WAT value, which has the steps as follows.

A key process is selected and a WAT (Wafer Acceptance Test) value after finishing the key process is used as a predict goal.

A predicting model is built.

One batch or plural batches of predictive wafers are prepared, and a Fault Detection and Classification data (FDC data) and a metrology data from the predictive wafers of the key process are collected.

The FDC data and the metrology data collected from the predictive wafers are inputted into the predicting model for processing a normal predicting procedure, and a predictive WAT (Wafer Acceptance Test) value by the predicting model is outputted.

The present invention provides the method for predicting and warning of WAT (Wafer Acceptance Test) value, which can help the manufacturing person to know the quality of any wafer associated with some predetermined key process by the predicting model. It does not need to spend much time to practically perform WAT (Wafer Acceptance Test). Once some abnormal WAT (Wafer Acceptance Test) values of the specific wafer are found, the manufacturing person can be informed and warned to closely monitor the specific wafer. Even the specific wafer can be applied with a compensation or improved means in the follow-up processes.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a training flowchart of a method for predicting and warning of WAT value according to the present invention;

FIG. 2 is a predicting flowchart of a method for predicting and warning of WAT value according to the present invention;

FIG. 3 is a distribution chart of predicted results simulated by an artificial neural networks system and real values; and

FIG. 4 is a distribution chart of predicted results simulated by a regression analysis system and real values.

### DETAILED DESCRIPTION OF THE PREFERRED EMBODIMENTS

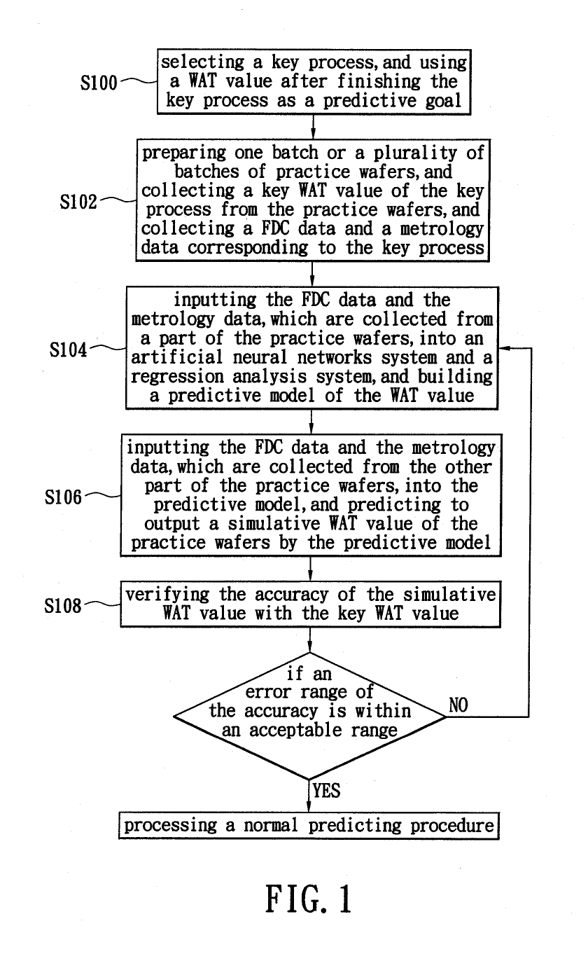

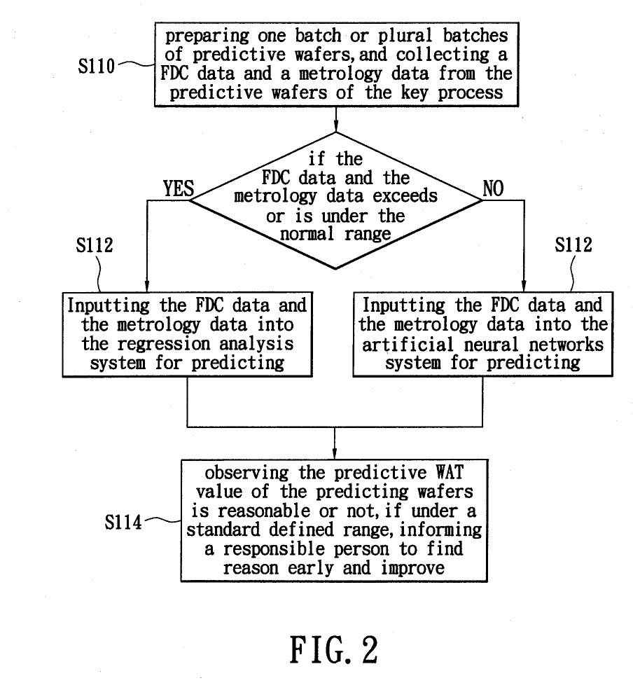

Reference is made to FIGS. 1 and 2. The present invention provides a method for predicting and warning of WAT (Wafer Acceptance Test) value, which includes the steps as follows. First, as shown in FIG. 1, a training procedure needs to be performed ahead, so as to build a predicting model. Then, as shown in FIG. 2, a predicting procedure is performed accordingly.

Reference is made to FIG. 1. The training procedure is performed in advance, which includes steps as follows. First, in step S100, a key process, which crucially affects quality among the manufacturing processes, is selected. For example, a typical wafer that starts out being a raw wafer may undergo the following processes: deposition, masking, etching, doping, metallization, and passivation. The key process, for example, would be the gate oxidation etching process, etc. A WAT (Wafer Acceptance Test) value after the key process finished is used as a predicted goal. Next, in step S102, one hundred batches of practice wafers are provided. From the 100 batches of practice wafers, a key WAT (Wafer Acceptance Test) value associated with the key process is tested and collected. The fault detection and classification data (FDC data) and the metrology data associated with the key process are also collected. The key WAT (Wafer Acceptance Test) value is real value (not predictive value), which is measured in a practical test by WAT (Wafer Acceptance Test) tools. The FDC data are the required parameter conditions in the key process, such as temperature and the acid concentration of washing solution. The metrology data are the real basic parameters of the structure formed after the key process finished, such as film thickness, etc.

Then, in step 104, the FDC data and the metrology data collected from 90 batches of the practice wafers are inputted into an artificial neural networks system, and a regression analysis system, so that a predicting model of WAT (Wafer Acceptance Test) value is built. The artificial neural networks system (ANN), usually called “neural network” (NN), they can be used to model complex relationships between inputs and outputs or to find patterns in data. The Regression analysis is widely used for prediction (including forecasting of time-series data). Use of regression analysis for prediction has substantial overlap with the field of machine learning. The ANN system and the regression analysis system are developed well before and not described in detail here. In step 106, the FDC data and the metrology data collected from the other 10 batches of the practice wafers are inputted in the predicting model. Then, the predicting model simulates and outputs a simulative WAT value of the 10 batches of the practice wafers, which are predictive values by simulated.

In step 108, the key WAT (Wafer Acceptance Test) value (real value) collected from the 10 batches of practice wafers is used to verify the simulated WAT (Wafer Acceptance Test) value (simulated value). Then, an error range of the simulated WAT (Wafer Acceptance Test) value is observed. If the error range is acceptable, then the predicting model has had a reliable accuracy, and a normal predicting procedure can be built consequently. If the error accuracy is over the acceptable range, then back to the step S104, and build a predicting model again. The 100 batches of practice wafers in the training procedure could be randomly selected out any 90 batches and the other 10 batches to process the above steps, such as building the predicting model, simulating by the predicting model for getting the predictive WAT (Wafer Acceptance Test) value, and verify the predictive WAT (Wafer Acceptance Test) value. The wafers can be repeatedly selected as testing samples, and use a cross-validation (such as Hold-Out Method, K-fold Cross Validation, or Leave-One-Out Cross Validation) to check the accuracy of the predicting model. However, there is not limitation in the number of the practice wafers in 100 batches. The sampling number of the batches of practice wafers would be different, also the sampling ratio of the practice wafers.

As shown in FIG. 2, a normal predicting procedure is performed, which includes the steps as follows. As shown in step S110, one batch or plural batches of predicting wafers are prepared to be defected. The FDC data and metrology data of the key process are collected from the predicting wafers (step S110). The key process in the predicting procedure need to match with the key process being selected in the training procedure. Next, the FDC data and the metrology data, which are collected from the predicting wafers, are inputted into the predicting model built by the training step (as shown in FIG. 1) to process a normal predicting procedure. A predict WAT (Wafer Acceptance Test) value of the predicting wafers is output by the predicting model. The predicting model includes the artificial neural networks system and the regression analysis system. As shown in left S112, if the FDC data and the metrology data exceed or is under the normal range, those data are inputted into the regression analysis system to predict and then a more accuracy result will be gained. In other way, as shown in right S112, if the FDC data and the metrology data are within the normal range, those data are inputted into the artificial neural networks system to predict (step S112).

Finally, as shown in step S114, the predictive WAT (Wafer Acceptance Test) value of the predicting wafers is surveyed that if it is reasonable or not. If those values are out of standard defined range, the responsible person of the related process is informed to find the reason and improve it as soon as possible (step S114). For example, a warning signal is generated, such as a voice or a short message including the abnormal WAT (Wafer Acceptance Test) value and the relative defective wafer's number. The warning signal could be sent out to a monitor.

According to the method for predicting and warning of wafer acceptance test value of the present invention, a simulative predicted result is illustrated as follows. The inventor practically prepares some batches of practice wafers, and collects the key WAT (Wafer Acceptance Test) value of one key process. The key process in this embodiment is a Gate Oxidation etching process. The FDC data and the metrology data corresponding to the key process are collected to build the predicting model including an artificial neural networks system and a regression analysis system. Then, the FDC data and the metrology data are inputted into the predicting model, and simulate to output the simulative WAT (Wafer Acceptance Test) value after finishing the key process. The key WAT (Wafer Acceptance Test) value (real value) collected before is used to verify the simulative WAT (Wafer Acceptance Test) value (predicting simulative value).

To observe this simulative predicted result of WAT (Wafer Acceptance Test) value in the key process (Gate Oxidation etching process) associated with the relative electrical parameters, the predictive WAT (Wafer Acceptance Test) value, which is simulated by the artificial neural networks system and the regression analysis system, most of them have an error percent under 3% as shown in the following table.

TABLE

| | | Predicting error |
|---|---|---|
| | Predicting error | of artificial |
| Related electrical | of regression | neural networks |
| parameter | analysis system | system |
| Electrical parameter 1 | 0.415% | 0.4280% |
| (TOX_AAFET_INV) | | |
| Electrical parameter2 | 1.185% | 1.3867% |
| (VL_LKI5ux10u) | | |
| Electrical parameter3 | 0.940% | 1.0859% |
| (VL_NKI5ux10u) | | |
| Electrical parameter4 | 1.276% | 1.6235% |
| (VL_NL5ux10u) | | |
| Electrical parameter5 | 1.448% | 1.9427% |
| (VL_P5ux10u) | | |
| Electrical parameter6 | 2.246% | 2.4346% |
| (VL_PK5ux10u) | | |
| Electrical parameter7 | 1.928% | 2.0357% |
| (VL_PL5ux10u) | | |
| Electrical parameter8 | 7.312% | 7.9287% |
| (VR_EB2) | | |
| Electrical parameter9 | 1.465% | 1.8778% |
| (VS_LKI5ux180) | | |
| Electrical parameter10 | 2.013% | 2.8184% |
| (VS_N5ux100) | | |
| Electrical parameter11 | 1.200% | 1.5045% |
| (VS_NKI5ux175) | | |
| Electrical parameter12 | 2.448% | 3.3795% |
| (VS_NL5ux120) | | |
| Electrical parameter13 | 3.411% | 5.1814% |
| (VS_P5ux100) | | |
| Electrical parameter14 | 2.898% | 3.8388% |
| (VS_PK5ux155) | | |
| Electrical parameter15 | 3.096% | 5.1002% |
| (VS_PL5ux120) | | |
| Electrical parameter16 | 0.450% | 0.5008% |
| (Y_M_ALLCBWL) | | |
| Electrical parameter17 | 0.216% | 0.2219% |
| (Y_M_WL_WL) | | |

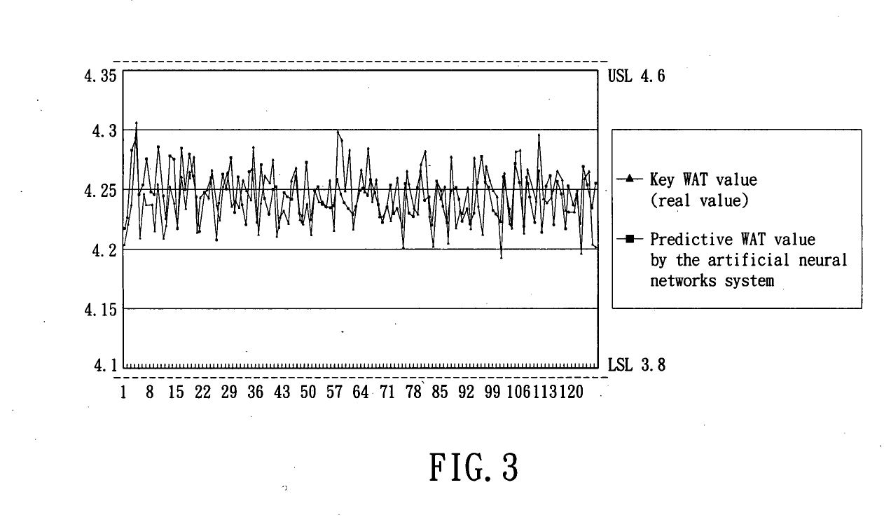

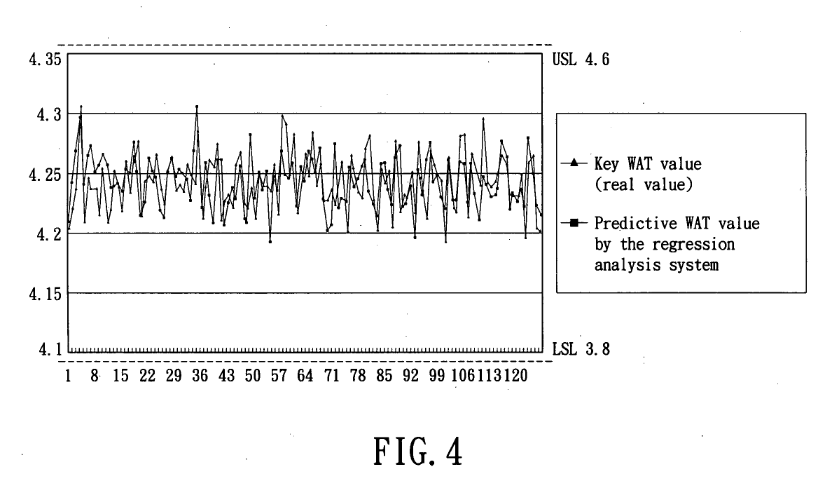

Reference is made in FIG. 3 and FIG. 4. The horizontal axis represents different wafers, and the vertical axis represents WAT (Wafer Acceptance Test) values. The predicted results simulated by the artificial neural networks system and the regression analysis system are close to the real value, all of which are within the standard range.

As described above, the method for predicting and warning of wafer acceptance test value of the present invention can accurately predict a WAT value associated with some predetermined key process. It is not necessary to practically test all wafers by WAT (Wafer Acceptance Test) tool, and the practical measuring time can be saved. By the predicting model of the present invention only, the responsible process person can predict and know the quality of any wafers after finishing the key process. If the predictive WAT (Wafer Acceptance Test) value of the specific wafers is abnormal, the responsible process person can be warned and noticed to closely monitor the specific wafer. Even a compensation or improved means can be applied to the specific wafer in the follow-up processes, such as adjusting the depth of ion implantation, etc. to improve the quality.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A method for predicting and warning of wafer acceptance test value, comprising the steps of:
selecting a key process, and using a wafer acceptance test value after finishing the key process as a predictive goal;
building a predicting model;
preparing one batch or a plurality of batches of predictive wafers, and collecting a Fault Detection and Classification data and a metrology data from the predictive wafers of the key process; and
inputting the Fault Detection and Classification data and the metrology data collected from the predictive wafers into the predicting model for processing a normal predicting procedure, and outputting a predictive WAT value by the predicting model.

2. The method as claimed in claim 1, wherein the step of building the predicting model further comprising:
preparing one batch or a plurality of batches of practice wafers, and collecting a key wafer acceptance test value of the key process from the practice wafers, and collecting a Fault Detection and Classification data and a metrology data corresponding to the key process;
inputting the Fault Detection and Classification data and the metrology data collected from a part of the practice wafers into an artificial neural networks system and a regression analysis system, and building the predicting model of the wafer acceptance test value;
inputting the Fault Detection and Classification data and the metrology data collected from the other part of the practice wafers into the predicting model, and predicting to output a simulative WAT value of the practice wafers by the predicting model; and
verifying the accuracy of the simulative wafer acceptance test value with the key wafer acceptance test value.

3. The method as claimed in claim 2, wherein in the step of verifying the simulative wafer acceptance test value with the key wafer acceptance test value, if an error exceeding a predetermined acceptable range, then building again the predicting model.

4. The method as claimed in claim 2, wherein the key wafer acceptance test value is real value measured by wafer acceptance test tools.

5. The method as claimed in claim 2, wherein the Fault Detection and Classification data is a required parameter conditions in the key process.

6. The method as claimed in claim 5, wherein the required parameter conditions in the key process includes temperature and an acid concentration of washing solution.

7. The method as claimed in claim 2, wherein the metrology data are real basic parameters of the formed structure after the key process finished.

8. The method as claimed in claim 7, wherein the real basic parameters of the formed structure includes a film thickness.

9. The method as claimed in claim 2, wherein during the normal predicting procedure, if the Fault Detection and Classification data and the metrology data exceed or are under a normal range, the regression analysis system is used to predict the WAT value.

10. The method as claimed in claim 9, wherein if the wafer acceptance test value is out of a standard defined range, generating a warning signal to inform a responsible person.

11. The method as claimed in claim 2, wherein during the normal predicting procedure, if the Fault Detection and Classification data and the metrology data are within a normal range, the artificial neural networks system is used to predict the wafer acceptance test value.

12. The method as claimed in claim 11, wherein if the wafer acceptance test value is out of a standard defined range, generating a warning signal to inform a responsible person.

13. The method as claimed in claim 2, wherein the key process includes a gate oxidation etching process.
